(19) United States
(12) Patent Application Publication
(10) Pub. No.: US 2010/0113732 A1
(43) Pub. Date: May 6, 2010

(54) Method Of Preparing New Silsesquioxane Filler Material

(76) Inventor: Larry Herbert Wood, Campbellsburg, KY (US)

Correspondence Address: DOW CORNING CORPORATION CO1232, 2200 W. SALZBURG ROAD, P.O. BOX 994, MIDLAND, MI, 48686-0994, US

(21) Appl. No.: 12/522,263

(22) PCT Filed: Nov. 30, 2007
(86) PCT No.: PCT/US07/24729

§ 371 Date: Jul. 7, 2009

Related U.S. Application Data
(60) Provisional application No. 60/881,615, filed on Jan. 22, 2007.

(51) Int. Cl. C08G 77/24

(52) U.S. Cl. 528/42

(57) ABSTRACT

The invention discloses a method for the preparation of high surface area methylsilsesquioxane resin particles. The particles are formed by the hydrolysis and condensation of methyltrichlorosilane followed by separation and drying. By this process, by-products and waste are converted into commercially valuable materials.

### CROSS-REFERENCE TO RELATED APPLICATIONS: NONE

NONE

### BACKGROUND OF THE INVENTION

The present application discloses a method for the preparation of methyl silsesquioxane resin particles. The particles are formed by the hydrolysis and condensation of monomethyltrichlorosilane (also known as methyltrichlorosilane) in HCL followed by separation and drying. By this process, by-products and waste are converted into commercially valuable materials.

Methyltrichlorosilane is made as a byproduct in the production of dimethyldichlorosilane and in quantities well above current market demands. Current outlets for this material yield an economic return that is little above the breakeven price. Thus it is desirable to develop a product from methyltrichlorosilane that can enhance the value of this material to the producer.

One such product would be a filler. Such fillers should have a small particle size and a high surface area to have the greatest efficacy. However, when MeSiCl₃ and water are brought into contact with each other, particularly under conditions of little agitation, the resulting hydrolysis product consists of large, hard lumps of siloxane. Such material, even when ground to a fine powder, provides little if any reinforcing character when used as a filler even though it may exhibit surface areas of over 250 m²/gm. This lack of reinforcement is believed to be due to the high surface area of the particle resulting from small cracks and pores in the particle which the polymer being reinforced cannot enter, thus causing the particle to act as if it had a very low surface area.

When the reactants, MeSiCl₃ and water are brought together under very dilute conditions, the resulting hydrolysate tends to be of a low molecular weight that is generally soluble in a solvent. Such lower molecular weight resins can be used in coatings or as ingredients of coating products, but they generally do not find application as a filler.

The present inventors have produced a methyl silsesquioxane (MeSiO_{3/2}) that not only is of a high molecular weight, which gives it high temperature stability, but particles derived from such material also have a high surface area that makes them attractive for filler applications in sealants, rubbers, and the like.

### BRIEF SUMMARY OF THE INVENTION

The present invention comprises a method for the preparation of particles having a large surface area from methyltrichlorosilane. The method comprises first reacting methyltrichlorosilane with aqueous HCl to form a liquid phase and a solid phase. The solid phase is separated from the liquid and dried to form high surface area particles.

### DETAILED DESCRIPTION OF THE INVENTION

The method of the invention essentially comprises hydrolyzing and condensing methyltrichlorosilane to form resin particles followed by separating the resin particles and drying them. The silicone resin forming the silicone resin particles comprises methyl silsesquioxane resin expressed by the unit formula MeSiO_{3/2}.

The medium in which the hydrolysis and condensation reactions of the methyltrichlorosilane compound or other silane compounds is aqueous HCl. The HCl should generally be at a sufficient concentration to inhibit the formation of low molecular weight species. In one embodiment, the HCl is at a concentration greater than 10 wt. %. In an alternative embodiment, the HCl is at a concentration greater than 20 wt. %. In an alternative embodiment, the HCl is at a concentration greater than 30 wt. %. In an alternative embodiment, the HCl is at a concentration greater than 35 wt. %. In yet an alternative embodiment, the HCl is at a concentration of about 37 wt. %.

In one embodiment, the methyltrichlorosilane is added to a solution of the aqueous HCl with agitation. In another embodiment, the HCl is added to a solution of the methyltrichlorosilane with agitation. If desired, the methyltrichlorosilane can be diluted in a solvent for the reaction.

In an alternative embodiment, the reaction of the methyltrichlorosilane and the aqueous HCl can be run by bubbling gaseous methyltrichlorosilane through aqueous HCl. If desired, the gaseous methyltrichlorosilane can be diluted with a material that doesn't react with it. For example, the gaseous methyltrichlorosilane could be diluted with nitrogen and this gaseous mixture then bubbled through the aqueous HCl.

The rate of addition in either of the above processes is not critical. For example, it can be added quickly (e.g., over a period of a few seconds to a few minutes, for example 5 seconds to 5 minutes), provided the reaction medium is contained within the reaction vessel. In another example, the methyltrichlorosilane and aqueous HCl can be mixed more slowly over a period of several minutes to several hours (e.g., 5 minutes to 24 hours) by, for example, dropwise addition or slow gaseous addition.

The ratio of aqueous HCl to methyltrichlorosilane used in the reaction can vary over a wide range. For example, the ratio of HCl:methyltrichlorosilane can be a molar ratio of 100:1 to 1:100. In another embodiment the ratio can be 1:25 to 1:75. In another embodiment, the ratio can be a molar ratio of 5:1 to 1:5.

The temperature of the reaction medium in which the methyltrichlorosilane is subjected to the hydrolysis and condensation reaction, is in the range from 0 to 100° C. or, in an alternative embodiment, from 0 to 40° C. An aqueous medium at a temperature lower than 0° C. will result in slower reaction rates. When the temperature of the reaction medium is too high, the reactant rate will be very fast and may result in larger particles.

If desired, small amounts of others silanes can be included in the reaction media. These can include, for example, dimethyldichlorosilane, silicon tetrachloride, trimethylchlorosilane, methyhydrogendichlorosilane, and trichlorosilane. These which may be in the methyltrichlorosilane as a by-product or impurity or they may be intentionally added to slightly alter the composition of the final resin. In one embodiment, the other silanes can be included in a weight percentage of less than 10%, alternatively in a weight percentage of less than 1%, and alternatively in a weight percentage of less than 0.1%.

Once the hydrolysis and condensation reactions occur, a solid phase is formed. This can be in the form of solid particles, foam or the like. According to the process of the present invention, the solid phase is removed from the liquid phase and dried to form the particles. If desired, however, the reaction product can be manipulated to form a variety of particles before it is dried. For example, the mixture of the solid phase and the liquid phase can be blended to form smaller particles.

In one embodiment of the invention, the reaction product comprising the solid phase and the liquid phase is also diluted with water prior to the separation. This dilutes any remaining acid and allows for ease in further processing. The amount of water added in this step is not critical.

The solid phase is then removed from the liquid phase. This can be accomplished by known techniques such as heating under normal or reduced pressure, gravity settling of the particles, fluidization of wet particles in a hot air stream, spray drying of the dispersion or a conventional solid-liquid separation procedure such as filtration, centrifugation, decantation and the like to remove at least a part of the aqueous medium.

The particles are typically further dried by mechanical means, heat or the like (for example, an oven or a microwave). When the thus dried resin particles are in the form of loose cakes, it is usual that the cakes are disintegrated into discrete particles by using a conventional disintegrator such as jet mills, ball mills, hammer mills and the like.

If desired, the solid phase can be further washed or flushed with water or alternative diluents. This may improve the purity of the material.

While the silicone resin particles basically comprise the methylsilsesquioxane, the silicone resin may further comprise other types of siloxane units including other trifunctional units of the formula R¹SiO_{3/2}, difunctional units of the formula R¹₂SiO_{2/2}, monofunctional units of the formula R¹₃SiO_{1/2} and tetrafunctional units of the formula SiO_{4/2}, in which each R¹ is independently a hydrogen or a hydrocarbon group of 1-20 carbon atoms, such as, for example, an alkyl, an alkenyl, an aryl and the like. In one embodiment the molar fraction of trifunctional units is at least 80%.

The resultant particles generally have a surface area greater than about 100 m²/g, alternatively greater than about 150 m²/g, alternatively greater than about 200 m²/g.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %.

### EXAMPLE 1 (COMPARATIVE)

105.3 grams of MeSiCl₃ and 804.5 grams of n-pentane were mixed in a 3.8 liter jug. A magnetic stirring bar was added and the jug contents were agitated with a magnetic stirrer as 8.4 grams of water was added drop wise over a one hour period of time. The jug contents were then stirred overnight. The drop wise addition of water was continued until 17.4 more grams of water was added as the jug contents were stirred with the magnetic stirrer. The jug contents were then stirred for one hour with no additions. Agitation was then stopped and the jug contents allowed to separate. The pentane phase was poured off and about a half gallon of water was added to the remaining gels. White gels separated from the aqueous phase in the jug. After agitating briefly, the jug contents were dumped and the gels separated and placed on paper towels to dry. After drying to a powder the gels were analyzed for surface area using a BET technique after outgasing under helium purge at 250° C. overnight. A surface area of 193.7 square meters per gram was determined.

### EXAMPLE 2: (COMPARATIVE)

74 grams of MeSiCl₃ and 567.2 grams of pentane were added to a 2-liter 3-neck flask then water was added drop wise with vigorous stirring with a magnetic stirrer over a four hour period during which 54.5 ml of water was added. During this time 83 grams of additional MeSiCl₃ was added in three equal aliquots. At the end of the 4 hour period 347 grams of additional water was added and the flask contents were stirred for an additional 10 minutes. The flask contents were then emptied into a separatory funnel where the solid resin material was separated from the aqueous phase and pentane. The resin was allowed to air dry and then analyzed for surface area as in example 1. The surface area was 79.0 square meters per gram.

### EXAMPLE 3: (COMPARATIVE)

133 grams of MeSiCl₃ and 762.4 grams of pentane were added to a 2-liter 3-neck flask. 9.2 gram of water was slowly added over a 34 minute period of time with vigorous mixing. The resulting slurry was then allowed to stir for 187 minutes. Twenty-five ml of additional water was slowly added over an 80 minute period of time. The flask contents were allowed to stir overnight then 1 liter of water was added and stirring was continued for 100 minutes. The solids were separated from the aqueous phase and the pentane was allowed to air dry. After air drying the resin was heated in a 1000 watt microwave oven for six minutes to drive off moisture. The surface area of the resulting dry white powder was 147 square meters per gram as measured by the process of Example 1.

### EXAMPLE 4

1961 grams of 37% aqueous HCl were put in a 4 liter open top vessel and agitated using a magnetic stirrer. 550 grams of MeSiCl₃ were added as quickly as possible without generating so much foam that it overflowed the vessel (about 5 minutes). About 4 liters of water was then added to dilute the acid. The solids were filtered from this slurry using a 5 micron polyester felt filter bag. The filtered resin was slurried in water and the slurry placed in a household blender for about 1 minute to reduce particle size. This blended slurry was again filtered using the same filter bag. The solids were further washed by pouring approximately 10 liters of water over the resin in the filter bag. The resin in the bag was pressed dry then placed in a 150° C. oven for several hours then heated in a 1000 watt microwave oven for 12 minutes. The solids content of the dried resin powder were 99.3 wt % and the HCl content was 280 ppm. Surface area of the dried resin was 227 square meters per gram as measured by the process of Example 1.

### EXAMPLE 5

2.5 liter of 37% aqueous HCl were added to a 18.93 liter plastic pail and, while agitating the acid with a plastic rod, MeSiCl₃was slowly added. When the resulting slurry became difficult to stir, water was added to dilute it. A total of about 3 liters of MeSiCl₃ was added. This slurry was diluted 50:50 in water and then the resin filtered out with a 5 micron polyester felt filter bag. The filtered resin was again slurried with water and the slurry mixed in a blender for 30 seconds to reduce particle size. Following filtering again of the slurry and air drying, the resin was taken to dryness using a 1000 watt microwave oven. The dried resin was 99.5 wt % solids, contained 150 ppm HCl and had a surface area of 147.5 square meters per gram as measured by the process of Example 1. A five gram sample of this resin was placed in a 350° C. oven for 23 hours and the surface area was measured again to be 284.2 square meters per gram as measured by the process of Example 1. Upon retesting 24 hours later the same sample was measured to be 282.7 square meters per gram as measured by the process of Example 1, showing that the increase in surface area obtained upon heating to 350° C. was retained.

### Foam Reactor Examples

### EXAMPLE 6

Nitrogen was bubbled through MeSiCl₃ at about 0.6 liter/min and the resultant nitrogen/MeSiCl₃ fed into a reactor. Concentrated aqueous HCl was also fed into the reactor at a rate of 18 ml/min. The nitrogen/MeSiCl₃ vapor stream entered the reactor through a spherical gas dispersion stone. Over 6.5 hours, 433 grams of MeSiCl₃ was fed. The methyl silsesquioxane foam and excess acid spilled out of the reactor and was collected in a collection vessel. The methyl silsesquioxane foam was separated from the acid by phase separation, collected in a filter bag, washed with water, spread out on an absorbent surface, and allowed to dry at room temperature. About 95 grams of a white powder was left after drying which was 98.8 wt % solids and contained 426 ppm HCl. The surface area of the powder was 260.9 square meters/gm as measured by the process of Example 1.

### EXAMPLE 7

A reaction ran in the same apparatus as described in Example 6 for several hours at rates similar to Example 6. At the end of this time care was taken to wash the foam gently and separate the methyl silsesquioxane which remained as a foam from the methyl silsesquioxane which mixed with the aqueous acid in the foam collection vessel. After drying each portion of product, 25 grams of methyl silsesquioxane which had remained in the foam phase was collected and 48 grams of methyl silsesquioxane was collected which had been filtered from the aqueous acid phase. The methyl silsesquioxane from the foam was 98.5 wt % solids and had 788 ppm HCl with a surface area of 203.9 square meters/gram as measured by the process of Example 1. The methyl silsesquioxane from the aqueous acid phase was 99 wt % solids, had 630 ppm HCl and had a surface area of 247.8 square meters/gram as measured by the process of Example 1.

### EXAMPLE 8

Nitrogen was bubbled through MeSiCl₃ in an 800 ml stainless steel cylinder at about 2 liters/min and the resultant nitrogen/MeSiCl₃ was fed into a 7.62 cm diameter, 30.38 cm tall reactor. Concentrated aqueous HCl was fed into the reactor at about 20 ml/min. The nitrogen/MeSiCl₃ vapor stream entered the reactor through a spherical gas dispersion stone. The methyl silsesquioxane foam and excess acid spilled out of the reactor and was collected in a collection vessel. A total of 690 grams of MeSiCl₃ was fed over 6 hours and 20 minutes. The foam was collected, washed, collected in a Buchner vacuum funnel using a water aspirator to pull a vacuum, and allowed to dry at room temperature. 134 grams of dry powder were collected which were 98.6 wt % solids, 677 ppm HCl and had a surface area of 237.2 square meters/gram as measured by the process of Example 1.

### EXAMPLE 9

The apparatus as described in Example 8 was used with a reactor that was 2.54 cm in diameter and 30.48 cm tall. The nitrogen flow rate was about 1 liter/min and the acid flow rate was about 20 ml/min. The nitrogen/MeSiCl₃ vapor stream entered the reactor through a spherical gas dispersion stone. Over a 4½ hour period 311 grams of MeSiCl₃ was fed. The foam was collected, washed, and dried at room temperature as in example 8.72 grams of dry powder were collected which were 98.9 wt % solids, 648 ppm HCl, and had a surface area of 249.5 square meters/gram as measured by the process of Example 1.

### EXAMPLE 10

Nitrogen was bubbled through MeSiCl₃ in an 800 ml stainless steel cylinder at about 2 liters/min and the resultant nitrogen/MeSiCl₃ was fed into a 7.62 cm diameter, 30.38 cm tall reactor. Concentrated aqueous HCl was fed into the reactor at about 100 ml/min. The nitrogen/MeSiCl₃ vapor stream entered the reactor through a spherical gas dispersion stone. Over a 4.5 hour period 958 grams of MeSiCl₃ was fed. The methyl silsesquioxane foam and excess acid spilled out of the reactor and was collected in a collection vessel. The excess acid was recycled to the reactor at the prescribed rate. The foam was collected, washed, collected in a Buchner vacuum funnel using a water aspirator to pull a vacuum, and allowed to dry at room temperature. 264 grams of dry powder was collected which was 98.5 wt % solids, 1140 ppm HCl and had a surface area of 262.5 square meters/gram as measured by the process of Example 1.

### EXAMPLE 11

HCl was bubbled through MeSiCl₃ in an 800 ml stainless steel cylinder which was heated to maintain a consistent temperature of 25° C. at about 4.3 liters/min and the resultant HCl/MeSiCl₃ was fed into a 3.81 cm diameter, 60.96 cm tall reactor. Concentrated aqueous HCl was fed into the reactor at about 100 ml/min. The HCl/MeSiCl₃ vapor stream entered the reactor through a spherical gas dispersion stone. Over a 3 hour period about 300 g of MeSiCl₃ was fed. The methyl silsesquioxane foam and excess acid spilled out of the reactor and was collected in an 18.93 liter collection vessel. The excess aqueous acid was recycled to the reactor at the prescribed rate. HCl gas was sent to a scrubber. The foam was collected, washed, collected in a Buchner vacuum funnel using a water aspirator to pull a vacuum, and allowed to dry at room temperature. The final resin was 97.9 wt % solids, had 1875 ppm HCl and had a surface area of 192.9 square meters/gram as measured by the process of Example 1.

### EXAMPLE 12

This experiment was run in the same apparatus as described in Example 11 with the exception of using a differently sized reactor. A 10 molar % SiCl₄ in MeSiCl₃ mixture was prepared. The SiCl₄/MeSiCl₃ mixture was loaded into the 800 ml stainless steel cylinder which was heated to maintain a temperature of 20° C. and the reactor was about 5.08 cm in diameter and about 66.04 cm tall. The HCl flow was set at about 2 liters/min and the concentrated aqueous acid flow was about 137 ml/min. The HCl/SiCl₄/MeSiCl₃ vapor stream entered the reactor through a spherical gas dispersion stone. Over a 2.75 hour period about 300 grams of SiCl₄/MeSiCl₃ mixture was fed to the reactor. The foam was collected, washed, collected in a Buchner vacuum funnel using a water aspirator to pull a vacuum, and allowed to dry at room temperature. The final resin was 97.9 wt % solids, had 920 ppm HCl and had a surface area of 219.6 square meters/gram as measured by the process of Example 1.

### EXAMPLE 13

This experiment was run in the same apparatus as described in Example 12. A 10 molar % Me2SiCl2 in MeSiCl₃ mixture was prepared. The Me₂SiCl₂/MeSiCl₃ mixture was loaded into the 800 ml stainless steel cylinder which was heated to maintain a temperature of 20° C. The HCl flow was set at about 2 liters/min and the concentrated aqueous acid flow was about 137 ml/min. Over a 2.5 hour period about 300 grams of Me₂SiCl₂/MeSiCl₃ mixture was fed to the reactor. The foam was collected, washed, collected in a Buchner vacuum funnel using a water aspirator to pull a vacuum, and allowed to dry at room temperature. The final resin was 98.8 wt % solids, had 572 ppm HCl and had a surface area of 106.8 square meters/gram as measured by the process of Example 1.

That which I claim is:

1. A method for the preparation of particles having a large surface area from methyltrichlorosilane comprising:
reacting methyltrichlorosilane with aqueous HCl to form a liquid phase and a solid phase;
separating the solid phase from the liquid phase; and
drying the solid phase to form particles with high surface area.

2. The method of claim 1 in which the aqueous HCl is at a concentration greater than 30 wt. %.

3. The method of claim 2 in which the aqueous HCl is at a concentration greater than 35 wt. %.

4. The method of claim 3 in which the HCl is at a concentration of about 37 wt. %.

5. The method of claim 1 in which the solid phase is manipulated to decrease the size of the particles.

6. The method of claim 1 in which the methyltrichlorosilane is reacted with the aqueous HCl by adding the methyltrichlorosilane to a solution of the aqueous HCl while the reactants are agitated.

7. The method of claim 1 in which the methyltrichlorosilane is reacted with the aqueous HCl by bubbling methyltrichlorosilane through the aqueous HCl.
